(19) United States
(12) Patent Application Publication
(10) Pub. No.: US 2008/0180426 A1
(43) Pub. Date: Jul. 31, 2008

(54) LUMINANCE CONTROL METHODS AND DISPLAY DEVICES

(75) Inventors: Ping-Lin Liu, Tainan City (TW); Du-Zen Peng, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Miao-Li Country (TW)

(21) Appl. No.: 11/969,942

(22) Filed: Jan. 7, 2008

(30) Foreign Application Priority Data
Jan. 26, 2007 (TW) 96102993

(51) Int. Cl. G09G 5/00; G09G 3/36

(52) U.S. Cl. 345/207; 345/87

(57) ABSTRACT

A display device is provided. The display device includes a display panel outputting corresponding luminance according to a luminance control signal. The display device further includes a luminance detection device detecting ambient luminance in real time, and outputting a detected voltage according to the detected ambient luminance. A luminance control device of the display device outputs the luminance control signal at a predetermined time interval for adjusting the luminance of the display panel according to the detected voltage.

### BACKGROUND OF THE INVENTION

1. Field of the Invention

The invention relates to a display device, and more particularly to a luminance detection device of a display device.

2. Description of the Related Art

Liquid crystal displays (LCD), a kind of Flat Panel Display (FPD), are composed of a plurality of color or monochrome pixels in front of a light source or reflector. A layer of liquid crystal is inserted between two glass substrates, the first of which is a color filter. A plurality of transistors is buried in the second substrate. Electric field is introduced as a current passes through the transistors, deflecting the liquid crystal molecules, changing the polarization of the incident light. Next, the incident lights with different polarizations are filtered by a polarizer. Thus, each pixel obtains an individual brightness.

Organic light emitting diodes (OLED) are another display device implemented in FPDs. An OLED applies a voltage to an organic molecular or polymer material to emit light. Due to the self emission characteristics of the OLED, dot matrix type displays have been produced that exhibit light weight, slim profile, high contrast, low power consumption, high resolution, fast response time, no backlight, and full viewing angle. Additionally, the potential OLED panel sizes range from 4 mm micro-display to 100 inch outdoor billboards. Thus, the OLED display is regarded a next-generation FPD.

In the conventional luminance control method for a panel display device, a luminance detecting circuit detects the ambient luminance in real time. The panel display device adjusts the panel luminance in real time. As the ambient luminance changes, the luminance of the panel display device changes accordingly. Inaccurate detection results often occur, however, due to noise in the luminance detecting circuit. Panel luminance adjustments based on inaccurate detection results in mismatching with ambient light. Additionally, the panel display device will flicker in response to transient changes in the ambient luminance, resulting in excessive power consumption.

### BRIEF SUMMARY OF THE INVENTION

Display devices are provided. An exemplary embodiment of a display device comprises a display panel emitting light according to a luminance control signal. The display device further comprises a luminance detection device for real-time detection of ambient luminance and subsequent output of a corresponding detected voltage. The display device also includes a luminance control device outputting the luminance control signal at a predetermined time interval for adjusting the luminance of the display panel according to the detected voltage.

Another exemplary embodiment of a display device comprises a display panel outputting corresponding luminance according to a luminance control signal, a luminance detection device detecting ambient luminance in real time and outputting a detected voltage according to the detected ambient luminance at a predetermined time interval. This embodiment further comprises a luminance control device outputting the luminance control signal according to the detected voltage.

An exemplary embodiment of a luminance control method for controlling luminance of a display panel comprises detecting ambient luminance in real time in real time and generating a detected result at a predetermined time interval, and outputting a luminance control signal for adjusting the luminance of the display panel according to the detected result.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 illustrates a display device according to an embodiment of the invention;

FIG. 2 schematically illustrates a luminance adjusting device according to an embodiment of the invention

FIG. 3 schematically illustrates the waveforms of the nodes in the luminance adjusting device 14A and the signal sources shown in FIG. 2;

FIG. 4 schematically illustrates a luminance adjusting device according to another embodiment of the invention;

FIG. 5 schematically illustrates the waveforms of the nodes in the luminance adjusting device 14B and the signal sources shown in FIG. 4; and

FIG. 6 schematically illustrates a luminance adjusting device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

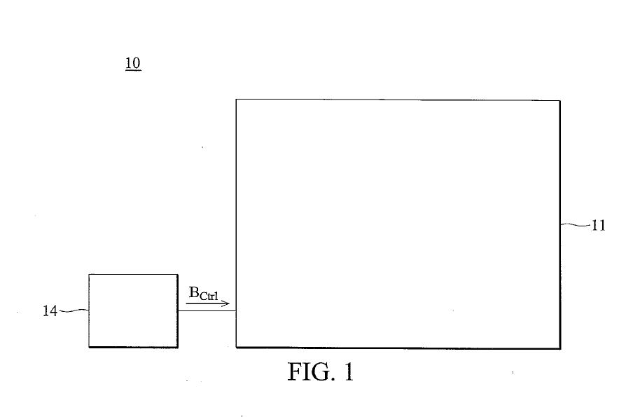

FIG. 1 illustrates a display device 10 according to an embodiment of the invention. The display device 10 comprises a display panel 11 and a luminance adjusting device 14, wherein the display panel 11 outputs corresponding luminance according to the luminance control signal B_{Ctrl} generated by the luminance adjusting device 14. The display panel can be a liquid crystal panel or an organic light emitting diode panel.

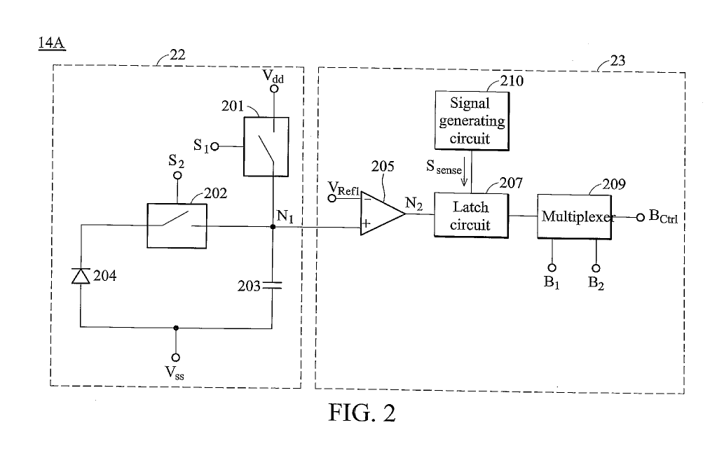

FIG. 2 schematically illustrates a luminance adjusting device 14A according to an embodiment of the invention. The luminance adjusting device 14A comprises a luminance detection device 22 and a luminance control device 23. The luminance detection device 22 detects the ambient luminance in real time and comprises two switching circuits 201 and 202 for controlling ambient luminance detection. The switching circuits 201 and 202 are turned on and off according to the control signals S₁ and S₂ respectively, wherein the control signals S₁ and S₂ are complementary. When the switching circuit 201 is turned on, charging of a capacitor 203 through the power supply V_{dd} begins. When the switching circuit 201 is turned off, the switching circuit 202 is turned on, thus, light sensor 204 begins detection of the ambient luminance. At the same time, charging or discharging of the capacitor 203 begins according to the detected ambient luminance, generating a detected voltage at node N₁ according to the charges stored in capacitor 203. Node N₁ is connected to a non-inverse input terminal of a comparison circuit 205 in the luminance control device 23, and the inverse input terminal of the comparison circuit 205 is connected to a reference voltage V_{Ref1}. The comparison circuit 205 compares a difference between the currently detected voltage at node N₁ and the reference voltage V_{Ref1}, and outputs the comparison result to a latch circuit 207. The latch circuit 207 latches the comparison result, and outputs a detected result at the predetermined time interval according to a sensor signal Sₛₑₙₛₑ. The sensor signal Sₛₑₙₛₑ is generated at a predetermined time interval by a signal generating circuit 210 in response to various conditions. The signal generating circuit 210, for example, can generate the sensor signal Sₛₑₙₛₑ at a fixed time interval. In another example the signal generating circuit 210 determines whether a difference range between the current comparison result and a previous comparison result exceeds a predetermined range, and generates the sensor signal Sₛₑₙₛₑ when the difference range exceeds the predetermined range. In yet another example the signal generating circuit 210 calculates the maintenance period of the current comparison result output by the comparison circuit 205, and generates the sensor signal Sₛₑₙₛₑ when the maintenance period exceeds a predetermined period. The latch circuit 207 connects to and outputs the detected result to a multiplexer 209. The multiplexer 209 outputs a luminance control signal B_{Ctrl} chosen from a group of luminance signals B₁ and B₂ according to the detected result received from latch circuit 207. In one embodiment, the fixed time interval and the predetermined time interval described above can be set to exceed one frame, two frames, and similar, where one frame may be 1/60 s.

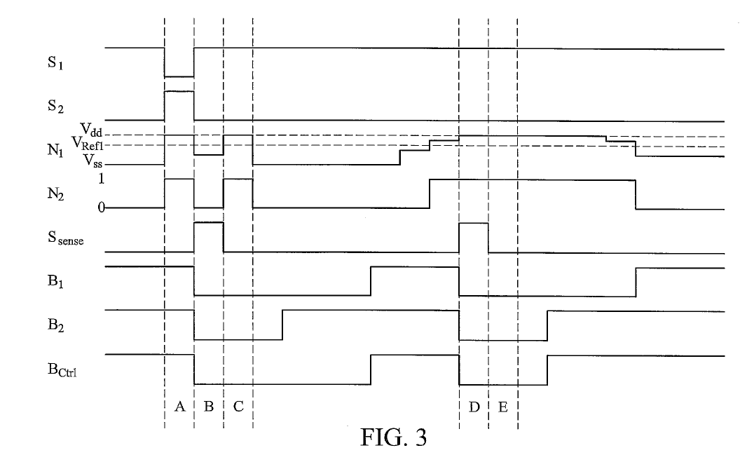

FIG. 3 schematically illustrates the waveforms of the nodes in the luminance adjusting device 14A and the signal sources shown in FIG. 2. In FIG. 3, the interval A is the duration for which the switching circuit 201 is turned on. When the switching circuit 201 is turned on, power supply charging of the capacitor 203 by the power supply V_{dd} begins, and the voltage at node N₁ is raised to V_{dd}. Because V_{dd} exceeds the reference voltage V_{Ref1}, the output node N₂ of comparison circuit 205 is at high voltage level. The interval B is the duration for which the switching circuit 202 is turned on. When the switching circuit 202 is turned on, the light sensor 204 detects the ambient luminance. At the same time, charging or discharging of the capacitor 203 begins according to the detected ambient luminance, and further generates a detected voltage at node N₁ according to the charges stored in the capacitor 203, wherein the detected voltage at node N₁ can be between Vₛₛ˜V_{dd}. In interval B, the output node N₂ of the comparison circuit 205 is at a low voltage level because the detected voltage at node N₁ is smaller than the reference voltage V_{Ref1}. In this embodiment, the signal generating circuit 210 generates the sensor signal Sₛₑₙₛₑ at a fixed time interval. Thus, in the interval B, the sensor signal Sₛₑₙₛₑ controls the latch circuit 207 to output the currently detected result, which is at low voltage level. Due to the low voltage level detected result, the multiplexer 209 chooses the luminance signal B₁ from the group consisting of luminance signals B₁ and B₂, and outputs the luminance signal B₁ as the luminance control signal B_{Ctrl}. At the beginning of the interval C, the luminance control signal B_{Ctrl} is still the luminance signal B₁ because the currently detected result is latched by the latch circuit 207. The luminance control signal B_{Ctrl} is thus not influenced by changes in ambient luminance or noise in the circuit. In interval D, the detected voltage at node N₁ exceeds the reference voltage V_{Ref1}, thus the output node N₂ of the comparison circuit 205 is at high voltage level. At the same time, sensor signal Sₛₑₙₛₑ controls the latch circuit 207 to output the currently detected result, which is at high voltage level. Thus, the multiplexer 209 chooses the luminance signal B₂ from the group consisting of luminance signals B₁ and B₂, and outputs the luminance signal B₂ as the luminance control signal B_{Ctrl}. At the beginning of interval E, the luminance control signal B_{Ctrl} is still the luminance signal B₂ because the currently detected result is latched by the latch circuit 207. The luminance control signal B_{Ctrl} is thus not influenced by changes in ambient luminance or noise in the circuit.

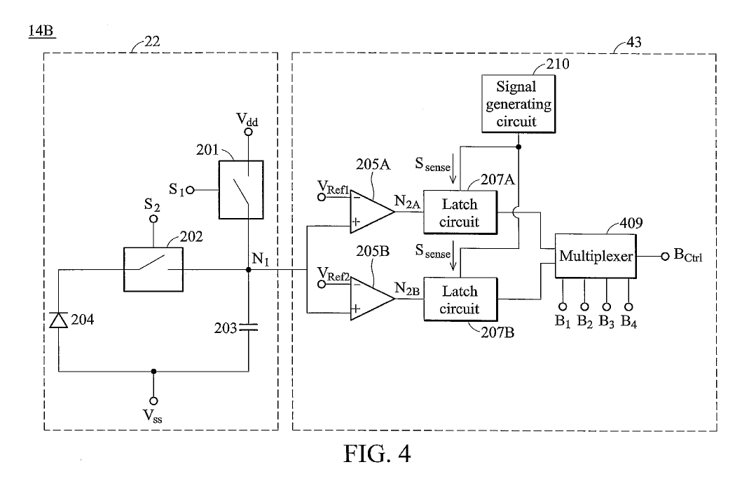

FIG. 4 schematically illustrates a luminance adjusting device 14B according to another embodiment of the invention. The luminance adjusting device 14B comprises a luminance detection device 22 and a luminance control device 43. As described above, the luminance detection device 22 detects the ambient luminance. When the switching circuit 201 is turned on, power supply charging of the capacitor 203 by the power supply V_{dd} begins. When the switching circuit 201 is turned off, the switching circuit 202 is turned on, thus the light sensor 204 starts to detect the ambient luminance. At the same time, charging or discharging of the capacitor 203 begins according to the detected ambient luminance, and generates a detected voltage at node N₁ according to the charges stored in the capacitor 203. Node N₁ is further connected to both non-inverse input terminals of comparison circuits 205A and 205B in the luminance control device 43, and the inverse input terminals of the comparison circuits 205A and 205B are connected to the reference voltages V_{Ref1} and V_{Ref2} respectively. The comparison circuits 205A and 205B compare the currently detected voltage at node N₁ to the reference voltages V_{Ref1} and V_{Ref2}, and output the comparison results to two latch circuits 207A and 207B respectively. The latch circuit 207A and 207B latch the comparison results respectively, and output detected results at the predetermined time interval according to a sensor signal Sₛₑₙₛₑ. According to the embodiments of the invention, the sensor signal Sₛₑₙₛₑ can be generated at a predetermined time interval by a signal generating circuit 210 under some different conditions. For example, the signal generating circuit 210 generates the sensor signal Sₛₑₙₛₑ at a fixed time interval, or the signal generating circuit 210 determines whether a difference range between the previous comparison results and the current comparison results outputted from the comparison circuits 205A and 205B exceeds a predetermined range, and generates the sensor signal Sₛₑₙₛₑ when the difference range exceeds the predetermined range, or the signal generating circuit 210 calculates the maintenance period of the comparison results outputted form the comparison circuit 205A and 205B, and generates the sensor signal Sₛₑₙₛₑ when the maintenance period exceeds a predetermined period. The latch circuits 207A and 207B connect to and output the detected results to a multiplexer 409. The multiplexer 209 outputs the luminance control signal B_{Ctrl} chosen from a group of luminance signals B₁, B₂, B₃ and B₄ according to the detected results received from latch circuits 207A and 207B. In one embodiment, the fixed time interval and the predetermined time interval described above can be set to exceed one frame, two frames, and similar, where one frame may be 1/60 s.

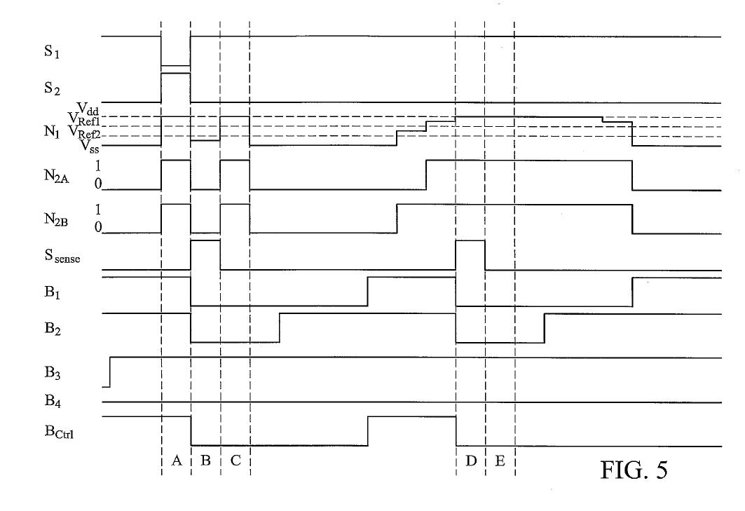

FIG. 5 schematically illustrates the waveforms of the nodes in the luminance adjusting device 14B and the signal sources shown in FIG. 4. In FIG. 5, the interval A is the duration for which the switching circuit 201 is turned on. When the switching circuit 201 is turned on, power supply charging of the capacitor 203 by the power supply V_{dd} begins, and the voltage at node N₁ is raised to V_{dd}. Because V_{dd} exceeds the reference voltage V_{Ref1} of the comparison circuit 205A and the reference voltage V_{Ref2} of the comparison circuit 205B, both the output node N_{2A} of the comparison circuit 205A and the output node N_{2B} of the comparison circuit 205B are at high voltage levels. The interval B is the duration for which the switching circuit 202 is turned on. When the switching circuit 202 is turned on, the light sensor 204 starts to detect the ambient luminance. At the same time, charging or discharging of the capacitor 203 begins according to the detected ambient luminance, and generates a detected voltage at node N₁ according to the charges stored in the capacitor 203, wherein the detected voltage at node N₁ can be between Vₛₛ˜V_{dd}. In the interval B, both the output node N_{2A} of the comparison circuit 205A and the output node N_{2B} of the comparison circuit 205B are low voltage levels, because the detected voltage at node N₁ is smaller than both the reference voltages V_{Ref1} and V_{Ref2}. In this embodiment, the signal generating circuit 210 generates the sensor signal Sₛₑₙₛₑ at a fixed time interval. Thus, in the interval B, the sensor signal Sₛₑₙₛₑ controls the latch circuits 207A and 207B to output the currently detected results, which are at low voltage levels. Due to the low voltage level detected results, the multiplexer 209 chooses the luminance signal B₁ from the group consisting of luminance signals B₁, B₂, B₃ and B₄, and outputs the luminance signal B₁ as the luminance control signal B_{Ctrl}. At the beginning of the interval C, the luminance control signal B_{Ctrl} is still the luminance signal B₁ because the currently detected result is latched by the latch circuit 207A and 207B. The luminance control signal B_{Ctrl} is thus not be influenced by changes in ambient luminance or noise in the circuit. In the interval D, the detected voltage at node N₁ exceeds both the reference voltages V_{Ref1}, and V_{Ref2}, thus both the output node

N_{2A} of the comparison circuit 205A and the output node N_{2B} of the comparison circuit 205B are at high voltage levels. At the same time, sensor signal Sₛₑₙₛₑ controls the latch circuits 207A and 207B to output the currently detected results, which are both at high voltage levels. Thus, the multiplexer 209 chooses the luminance signal B₄ from the group consisting of luminance signals B₁, B₂, B₃ and B₄, and outputs the luminance signal B₄ as the luminance control signal B_{Ctrl}. At the beginning of interval E, the luminance control signal B_{Ctrl} is still the luminance signal B₄ because the currently detected results are latched by the latch circuits 207A and 207B. The luminance control signal B_{Ctrl} is thus not influenced by the changes in ambient luminance or noise in the circuit.

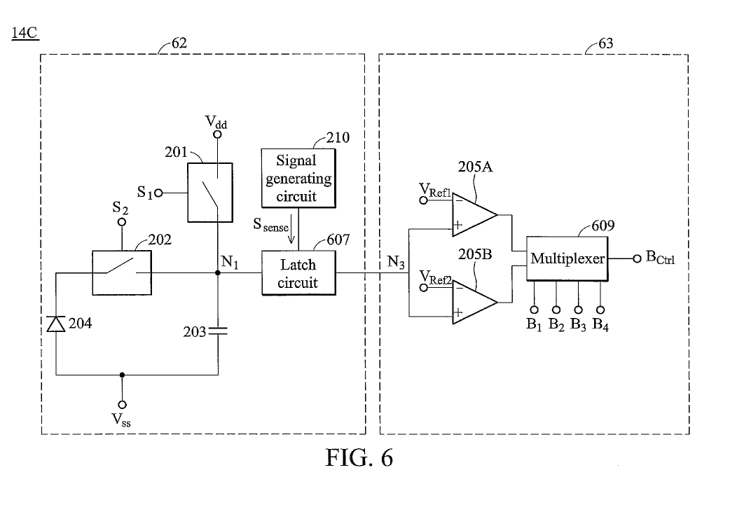

FIG. 6 schematically illustrates a luminance adjusting device 14C according to another embodiment of the invention. The luminance adjusting device 14C comprises a luminance detection device 62 and a luminance control device 63. The luminance detection device 62 detects the ambient luminance. When the switching circuit 201 is turned on, power supply charging of the capacitor 203 by the power supply V_{dd} begins. When the switching circuit 201 is turned off, the switching circuit 202 is turned on, thus the light sensor 204 starts to detect the ambient luminance. At the same time, charging or discharging of the capacitor 203 begins according to the detected ambient luminance, and generates an induced voltage at node N₁ according to the charges stored in the capacitor 203. Node N₁ is connected to a latch circuit 607. The latch circuit 607 latches the induced voltage, and outputs detected voltages at the predetermined time interval according to a sensor signal Sₛₑₙₛₑ. According to the embodiments of the invention, the sensor signal Sₛₑₙₛₑ can be generated at a predetermined time interval by a signal generating circuit 210 under some different conditions. For example, the signal generating circuit 210 generates the sensor signal Sₛₑₙₛₑ at a fixed time interval, or the signal generating circuit 210 determines whether a difference range between the previous induced voltage and the currently induced voltage exceeds a predetermined range, and generates the sensor signal Sₛₑₙₛₑ when the difference range exceeds the predetermined range, or the signal generating circuit 210 calculates the maintenance period of the induced voltage, and generates the sensor signal Sₛₑₙₛₑ when the maintenance period exceeds a predetermined period. The latch circuit 607 outputs detected voltages to the non-inverse input terminals of the comparison circuits 205A and 205B, and the inverse input terminals of the comparison circuits 205A and 205B are connected to the reference voltages V_{Ref1} and V_{Ref2} respectively. The comparison circuits 205A and 205B compare the currently detected voltages at node N₃ to reference voltages V_{Ref1} and V_{Ref2} respectively, and output the comparison results to a multiplexer 609. The multiplexer 609 outputs the luminance control signal B_{Ctrl} chosen from a group of luminance signals B₁, B₂, B₃ and B₄ according to the comparison results. In one embodiment, the fixed time interval and the predetermined time interval described above can be set to exceed one frame, two frames, and similar, where one frame may be 1/60 s.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display device, comprising:
a display panel outputting corresponding luminance according to a luminance control signal;
a luminance detection device detecting ambient luminance in real time and outputting a detected voltage according to the detected ambient luminance; and
a luminance control device outputting the luminance control signal according to the detected voltage at a predetermined time interval to adjust the luminance of the display panel.

2. The display device as claimed in claim 1, wherein the luminance detection device comprises:
a light sensor generating an induced current according to the detected ambient luminance; and
a voltage control circuit generating the detected voltage according to the induced current.

3. The display device as claimed in claim 2, wherein the luminance control device comprises:
a comparison circuit comparing a difference between the detected voltage and a reference voltage, and outputting a comparison result;
a latch circuit coupled to the comparison circuit for latching the comparison result and outputting a detected result at the predetermined time interval according to a sensor signal; and
a multiplexer coupled to the latch circuit for outputting the luminance control signal chosen from a plurality of luminance signals according to the detected result.

4. The display device as claimed in claim 3, further comprising a signal generating circuit generating the sensor signal at a fixed time interval.

5. The display device as claimed in claim 3, further comprising a signal generating circuit determining whether a difference range between the comparison result and a previous comparison result exceeds a predetermined range, and generating the sensor signal when the difference range exceeds the predetermined range.

6. The display device as claimed in claim 3, further comprising a signal generating circuit calculating a maintenance period of the comparison result, and generating the sensor signal when the maintenance period exceeds a predetermined period.

7. The display device as claimed in claim 1, wherein the predetermined time interval exceeds 1/60 s.

8. The display device as claimed in claim 1, wherein the display panel is a liquid crystal panel or an organic light emitting diode panel.

9. A display device, comprising:
a display panel outputting corresponding luminance according to a luminance control signal;
a luminance detection device detecting ambient luminance in real time and outputting a detected voltage according to the detected ambient luminance at a predetermined time interval; and
a luminance control device outputting the luminance control signal according to the detected voltage.

10. The display device as claimed in claim 9, wherein the luminance detection device comprises:
a light sensor generating an induced current according to the detected ambient luminance;
a voltage control circuit generating an induced voltage according to the induced current; and
a latch circuit coupled to the voltage control circuit for latching the induced voltage and outputting a detected voltage at the predetermined time interval according to a sensor signal.

11. The display device as claimed in claim 10, wherein the luminance control device comprises:
a comparison circuit coupled to the latch circuit for comparing a difference between the detected voltage and a reference voltage, and outputting a comparison result; and
a multiplexer coupled to the comparison circuit for outputting the luminance control signal chosen from a plurality of luminance signals according to the comparison result.

12. The display device as claimed in claim 11, further comprising a signal generating circuit generating the sensor signal at a fixed time interval.

13. The display device as claimed in claim 11, further comprising a signal generating circuit determining whether a difference range between the induced voltage and a previous induced voltage exceeds a predetermined range, and generating the sensor signal when the difference range exceeds the predetermined range.

14. The display device as claimed in claim 11, further comprising a signal generating circuit calculating a maintenance period of the induced voltage, and generating the sensor signal when the maintenance period exceeds a predetermined period.

15. A luminance control method for controlling luminance of a display panel, the luminance control method comprising:
detecting ambient luminance in real time and generating a detected result at a predetermined time interval; and
outputting a luminance control signal for adjusting the luminance of the display panel according to the detected result.

16. The luminance control method as claimed in claim 15, further comprising:
generating a detected voltage according to the detected ambient luminance;
comparing a difference between the detected voltage and a reference voltage, and generating a comparison result;
latching the comparison result and outputting the detected result at the predetermined time interval according to a sensor signal; and
outputting the luminance control signal chosen from a plurality of luminance signals according to the detected result.

17. The luminance control method as claimed in claim 15, further comprising:
generating a detected voltage according to the detected ambient luminance;
comparing a difference between the detected voltage and a first reference voltage and a second reference voltage and generating a comparison result;
latching the comparison result and outputting the detected result at the predetermined time interval according to a sensor signal; and
outputting the luminance control signal chosen from a plurality of luminance signals according to the detected result.

18. The luminance control method as claimed in claim 16, further comprising generating the sensor signal at a fixed time interval.

19. The luminance control method as claimed in claim 16, further comprising determining whether a difference range between the comparison result and a previous comparison result exceeds a predetermined range, and generating the sensor signal when the difference range exceeds the predetermined range.

20. The luminance control method as claimed in claim 16, further comprising calculating a maintenance period of the comparison result, and generating the sensor signal when the maintenance period exceeds a predetermined period.
